(19) United States
(12) Patent Application Publication
(10) Pub. No.: US 2008/0021822 A1
(43) Pub. Date: Jan. 24, 2008

(54) METHOD AND SYSTEM FOR RECEIVABLES MANAGEMENT

(75) Inventors: Brian D. HINTON, Chicago, IL (US); Carol R. Cushing, Chicago, IL (US); Jason Thomas Christensen, Downers Grove, IL (US); Kenneth Yuen, Lincolnwood, IL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: JPMORGAN CHASE BANK, N.A., NEW YORK, NY (US)

(21) Appl. No.: 11/779,105

(22) Filed: Jul. 17, 2007

Related U.S. Application Data
(60) Provisional application No. 60/807,648, filed on Jul. 18, 2006.

(51) Int. Cl. G06Q 40/00

(52) U.S. Cl. 705/40

(57) ABSTRACT

An embodiment of the present invention is directed to a computer implemented method or system for managing receivables which may involve maintaining a repository for receivables data comprising payment data; applying one or more automated rules to the payment data for identifying an exception wherein the exception represents a discrepancy between an actual payment and an expected payment; forwarding the exception to one or more designated recipients for resolution; tracking the exception; evaluating the exception to determine a root cause of the discrepancy; and storing data associated with the exception in the repository.

### CROSS REFERENCE TO RELATED APPLICATIONS

This patent application claims priority to U.S. Provisional Patent Application No. 60/807,648, filed Jul. 18, 2006, which is hereby incorporated by reference herein in its entirety.

### FIELD OF THE INVENTION

The present invention relates generally to managing receivables, and more specifically to a comprehensive receivables image and data repository for intelligent management of billing, receivables, credit management and other related information.

### BACKGROUND OF THE INVENTION

Receivables and banking in particular have had a long standing relationship. The relationship started with a service known as lockbox in an effort to generate working capital. Over time the lockbox relationship has transitioned to become a timely and reliable source for information about the payment trends and business practices of trading partners. Information delivery has been accomplished through addition of data and image capture and presentment solutions. Today, most companies of size (>$50 million in annual revenues) use a lockbox.

Banks first introduced lockbox services as a way to concentrate collection of paper-based payments. The lockbox locations were strategically positioned to take advantage of central locations with access to physical air transportation channels The result was a value proposition that created a low cost source of working capital based on minimizing the time it takes to collect and obtain available funds for paper-based checks. Adoption of a lockbox placed funds availability ahead of timeliness of receipt of remittance information adding anywhere from one to three days of additional time before a client could convert available cash in the form a deposit into an offsetting accounting transaction reducing the amount of open receivables attributed to a single buyer or trading partner relationship.

Over the years, banks have introduced many supplemental data and image capture solutions to deliver more timely updates of remittance information to the lockbox clients. Tools such as using the MICR line of a check could be used as a reasonable substitute index value to systematically identify a customer making a payment or the bank offering data capture of remittance detail with transmission of the detail to the client for auto cash posting were introduced.

The tools introduced by banks to aid in the capture and transfer of remittance information to the lockbox customer were passive in nature—meaning the bank would capture what is presented on either a check and/or associated document, but there was no ability to “qualify” the captured information prior to sending it on to the client for auto cash posting. To take advantage of the MICR and data capture services offered by the bank, each client would be required to invest in auto cash posting systems to qualify the information prior to attempting to update the client's A/R system of record.

The auto cash posting systems are used to validate and verify bank captured data to ensure that the customer relationship and invoice number(s) have been identified and the payment amount have been balanced to the amounts allocated across a group of invoices. Validated transactions do not require any human intervention and are completed in most cases one day after deposit. Transactions that are not validated are flagged as exceptions and require additional research on the part of the lockbox customer. The volume of exception transactions range from a minimum of 10% to as high as 40% of all payments depending on the industry and payment channel used by the buyer to pay obligations. Exceptions can take many days to resolve—creating a negative impact on order-to-cash metrics such as days sales outstanding and timely revenue recognition.

Most recently, the data capture solutions were expanded to include image capture and presentment of checks and corresponding documentation. This has proven to enhance the process further by supplying back-up documentation online to company personnel responsible for addressing exceptions that are detected through the auto cash posting of open invoice transactions. Both data capture and image presentment solutions have contributed to a rise in stature for Credit and Receivables Management as they represent key areas that can improve order-to-cash metrics.

Banks are not without competition when it comes to building tools that can help companies improve financial reporting. At the same time that lockbox services have been maturing to include robust data capture and transmission services, enterprise resource planning (ERP) systems have been implemented to address a need to consolidate all financial information into one place for the enterprise. The execution of consolidated reporting through an ERP system has proven to be somewhat elusive—as the cost to implement and the time to implement across a typical multi-national company operating with several subsidiaries has been difficult to accomplish and further the ERP solutions do not scale well to take on smaller companies faced with the same challenges.

Finally, businesses are looking for ways to form and maintain direct electronic relationships with trading partners. By forming electronic relationships, businesses can standardize the methods of input and output of transactions to and from their organizations in order to achieve cost savings and efficiency.

Accordingly, there is a need for an integrated receivables management system to address these and other inefficiencies.

### SUMMARY OF THE INVENTION

An embodiment of the present invention relates to a web-based image and data presentment solution for enhancing receivables management by using an innovative image and data presentment design that consolidates payment activity across multiple channels including lockbox, Automated Clearing House (ACH), Wire Transfer, Credit Card and Financial Electronic Data Interchange (FEDI). The system provides intelligent rules (e.g., business rules, etc.) to aid in identifying exceptions and offers workflow tools to help clients repair/resolve exceptions faster—resulting in gains in revenue recognition, reductions to order-to-cash cycle time and increased staff productivity.

According to an exemplary embodiment of the present invention, a computer implemented method for managing receivables comprises the steps of maintaining a repository for receivables data comprising payment data; applying one or more automated rules to the payment data for identifying an exception wherein the exception represents a discrepancy between an actual payment and an expected payment; forwarding the exception to one or more designated recipients for resolution; tracking the exception; evaluating the exception to identify a root cause of the discrepancy; and storing data associated with the exception in the repository.

In accordance with other aspects of this exemplary embodiment of the present invention, the method may further include the one or more automated rules based on MICR line data; the one or more automated rules based on one or more payer defined codes; the one or more automated rules based on one or more user defined codes; wherein the payment data comprises image data; wherein the payment data comprises remittance information comprising one or more of check stubs, invoice payments and coupons; wherein the payment data comprises data associated with one or more of checks, automated clearing house, electronic funds transfer, wire transfers, check returns, electronic data interchange, image replacement documents; the step of adding one or more supplemental notes associated with the exception intended for the one or more designated recipients; wherein the one or more designated recipients comprise one or more of customer service representatives, trading partners, participants, authorized users, business units, and business groups; the step of generating one or more reports based on one or more conditions; wherein each exception is identified by a reason code that identifies a repair reason; the step of enabling one or more users to access one or more personalized views for managing the receivables data and wherein the one or more users collaborate and communicate with each other.

According to an exemplary embodiment of the present invention, a computer implemented system for managing receivables, the system comprising: a repository for maintaining receivables data comprising payment data; and a module for applying one or more automated rules to the payment data for identifying an exception wherein the exception represents a discrepancy between an actual payment and an expected payment; forwarding the exception to one or more designated recipients for resolution; tracking the exception; and evaluating the exception to identify a root cause of the discrepancy; where data associated with the exception is stored in the repository.

### BRIEF DESCRIPTION OF THE DRAWINGS

In order to facilitate a fuller understanding of the present inventions, reference is now made to the appended drawings. These drawings should not be construed as limiting the present inventions, but are intended to be exemplary only.

FIG. 1 is an exemplary receivables management system, according to an embodiment of the present invention.

FIG. 2 is an exemplary flowchart illustrating a method for managing receivables, according to an embodiment of the present invention.

FIG. 3 illustrates an exemplary screen shot of Exception Management and Notes function, according to an embodiment of the present invention.

FIG. 4 illustrates an exemplary screen shot of a Supplemental Data Entry screen shot, according to an embodiment of the present invention.

FIG. 5 illustrates an exemplary screen shot of an Assigned to Workflow function, according to an embodiment of the present invention.

FIG. 6 illustrates an exemplary screen shot of Root Cause Exception Analysis function, according to an embodiment of the present invention.

FIG. 7 illustrates an exemplary screen shot for Exception Tracking & Analysis function, according to an embodiment of the present invention.

FIG. 8 illustrates an exemplary screen shot of a Receivables Management System, according to an embodiment of the present invention.

FIG. 9 illustrates an exemplary screen shot of a Robust Search Engine, according to an embodiment of the present invention.

FIG. 10 illustrates an exemplary screen shot of Check Return Re-Association function, according to an embodiment of the present invention.

FIG. 11 illustrates an exemplary screen shot of Split Payment and Remit Advice Re-Association function, according to an embodiment of the present invention.

### DETAILED DESCRIPTION OF THE INVENTION

A method and system of an embodiment of the present inventions are directed to managing receivables, and more specifically to a comprehensive receivables repository for intelligent management of receivables and other order to cash related data. An exemplary embodiment provides an Application Service Provider (ASP) hosted Internet environment that includes features and functions directed to a Consolidated Receivables Repository, Robust Search Engine, Exception Management and Notes, Assignment to Workflow, Root Cause Exception Tracking and Analysis, Check Return Re-Association, Split Payment and Remit Advice Re-Association and/or other related features. Additional features may include Invoice Matching and Reconciliation (e.g., build and maintain reconciliation business rules to match payments and remittance information to open receivables) and Predictive Lockbox (e.g., tracking history to predict payment events and behavior, etc.).

With invoice matching, clients may send invoice information to the bank (or other entity) to facilitate automated matching to identify exceptions the same-day of payment deposit, for example. Invoice matching may include online presentment of exceptions to the client from which a client can review, classify, collaborate and repair the item online prior to transmission for posting purposes—eliminating the need for clients to invest in enterprise systems.

Another feature of an embodiment of the present invention may be directed to a Predictive Lockbox which may include a trade finance tool that enables a lockbox customer to take advantage of “predicted payments” to accelerate the receipt of cash in advance of normal settlement clearing timeframes. With Predictive Lockbox, intelligence gathered by data mining historical information about payments received and invoices presented (which may be contained in a Receivables Repository) may be used to generate “predictions or forecasts” of future payments with a high level of confidence. The confidence level may be further strengthened when a payment originated by a Bank's disbursement relationship that is destined for a Bank's lockbox account may be identified at time the payment is authorized—allowing client's to leverage the Bank's balance sheet to accelerate payment for the receiver and delay payment funding for the payer—all from the same transaction.

For example, an exemplary scenario may involve a transaction and a deposit drawn from the same bank, Bank A. As Bank A is standing behind both the payer of funds and the receiver of funds, Bank A owns the relationship on both sides. Thus, Bank A has a level of confidence and comfort in this transaction. Bank A may offer an advance of funds to the receiver without requiring the payer to fund the account, thereby creating a loan based on the good standing of the payer. An embodiment of the present invention may intercept an obligation on the day it is received and inform the receiver that the payer has authorized payment and offer an advancement of funds to the receiver.

Another embodiment of the present invention is directed to optimizing receivables management. The receivables solution of an embodiment of the present invention may leverage a lockbox relationship to gain access to a number of integrated, electronic payment collection solutions to provide new opportunities to increase working capital, cost savings and efficiencies in the areas of billing, accounts receivable and credit management, etc. The expansion of web-based image capture and presentment solutions provides interactive applications to drive structured workflow, decisioning and online dialogue between distributive participants in the payment collection field.

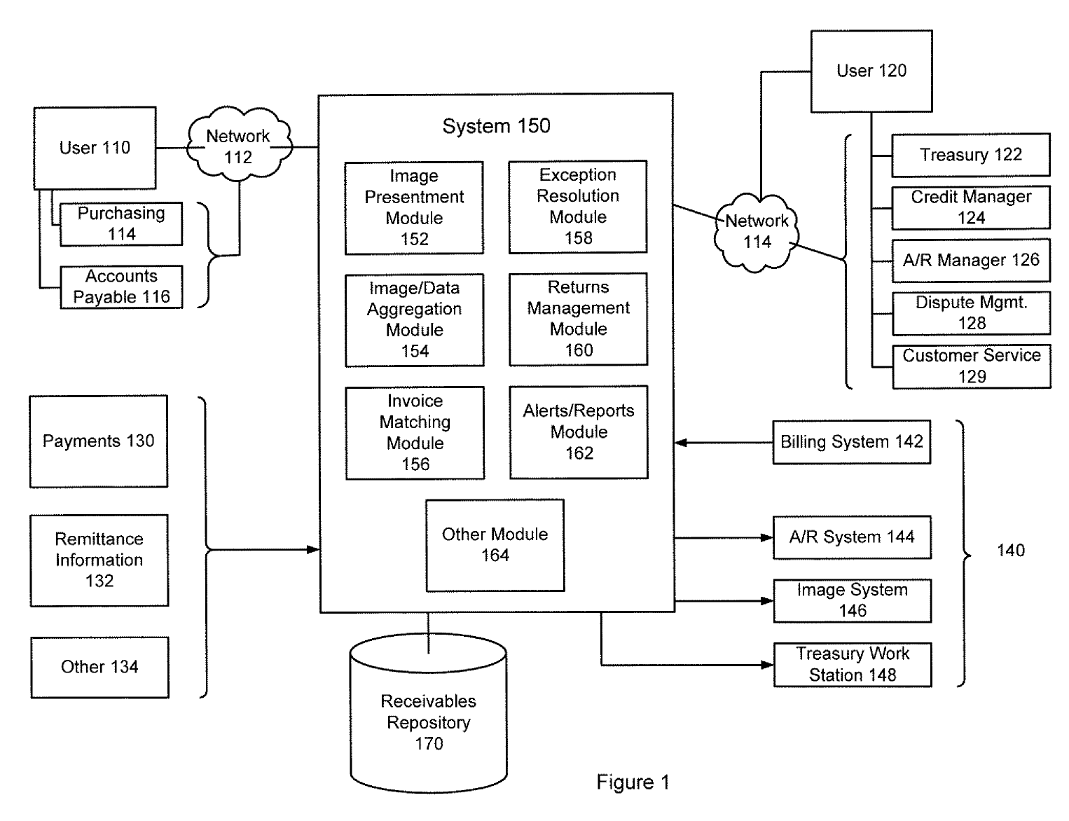

FIG. 1 is an exemplary receivables management system, according to an embodiment of the present invention. System 150 may provide various functionality and features associated with receivables management. More specifically, System 150 may include Image Presentment Module 152, Image/Data Aggregation Module 154, Invoice Matching Module 156, Exception Resolution Module 158, Returns Management Module 160, Alerts/Reports Module 162, and Other Module 164. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized.

The various modules of System 150 may access and/or store images and data at Receivables Repository 170. Additional repositories and/or databases may be implemented. For example, Repository 170 may represent one or more repositories located at a single location or across multiple locations. Repository 170 may include various types of databases, including relational databases. Various types of data may be stored at and/or accessed from Repository 170. For example, Repository 170 may store data and images, such as transaction level images and information. This data may be maintained for a period of time, e.g., up to ten years or more. This serves as a valuable tool for working capital management, financial reporting, audit and risk, customer service, cash posting, exceptions management, exception root cause analysis, time sensitive credit decisions, etc.

Repository 170 may receive data from various channels, such as Payments 130, Remittance Data 132 and/or other sources of information, as shown by 134. For example, Payments 130 may include checks, ACH, Electronic Funds Transfer (EFT), wire transfers, check returns, FEDI, Check 21, Image Replacement Document (IRD), credit cards and/or other payment channels. Remittance Data 132 may include check stubs, invoice payments, Optical Character Recognition (OCR) coupons, fax, email and/or other data presented or received through a variety of electronic channels. Receivables Repository 170 may also be expanded to include collection transactions that originate from anywhere in the world—making an embodiment of the present invention a global portal for receivables related transactions. In addition, Intelligent Character Recognition (ICR) and off-shore data entry resources may be implemented to capture data that would be stored on the data repository maintained at the bank or other institution.

Users may access System 150 through various modes of communication, such as Web Access, as shown by Network 112 and Network 114. Users 110, 120 may include providers, customers, banks, financial institutions, buyers, sellers, trading partners, and/or other entities. For example, User 110 may represent various units associated with an entity, including but not limited to Purchasing 114, Accounts Payable 116 and/or other units associated with a buyer. User 120 may also represent various units within an entity. The units may include Treasury 122, Credit Manager 124, Accounts/Receivables (A/R) Manager 126, Dispute Management 128, Customer Service 129 and/or other units associated with a seller or customer.

The security and entitlements supported by System 150 may provide multiple trading partners partitioned views of invoice, payment and remittance information that may be captured at various points throughout the normal transaction exchange process, thereby providing a consolidated tool to manage outstanding receivables.

System 150 may be a web-based presentment and delivery tool for access to images and data processed by a Provider. The images and data may include some or all lockbox transactions (e.g., check, corresponding documentation images, etc.) and images of return checks in one consolidated view or multiple personalized views. Repository 170 may be used as a research tool that complements the tools normally provided by an ERP or billing and/or receivables system of record. Repository 170 may be used by customer service, credit managers, receivables managers and deduction management research analysts, for example. An embodiment of the present invention consolidates the various forms of payment channels for collections into one or more enterprise information repository, represented by Repository 170. Further, Repository 170 may retain history of transactions received to accommodate risk and audit requirements associated with rules, policies and/or regulations, such as Sarbanes-Oxley.

An embodiment of the present invention offers a suite of business applications as shown by 140, which may include Billing System 142, Accounts Receivable (A/R) System 144, Image System 146, Treasury Work Station 148. The business applications may create benefits for customers in the areas of billing, accounts receivable, credit management, etc. Specialized applications may include a comprehensive set of business applications designed to address the issues associated with image presentment, electronic payment consolidation, accounts receivable matching, invoice presentment, payment origination, payment collection and cash application.

An embodiment of the present invention provides collaboration that includes support for online dialogue between parties and various entities, such as a bank and its customer and/or the bank's customer and its trading partner relationships. It also facilitates dialogue between departments within the company enterprise and support for real-time, online dialogue between trading partners, e.g., Buyer 110 and Seller 120. Collaboration may include providing and facilitating various management functionality, such as proactive notification of payment events and transaction conditions; cross-functional or departmental on-demand access to information; customer self service and information exchange with key trading partners; simplistic and structured business process management; optimized decision queuing and exception management; automated decision making based on client defined parameters; and trend analysis and benchmarking through historical data mining initiatives.

Image Presentment Module 152 may capture, retain and present images and information to a customer, trading partners and/or other users. The infrastructure may include a repository of receivables information, as shown by Repository 170. The information may be gathered from a number of bank-managed payment transaction platforms and systems that may be external to a provider (e.g., bank, financial institution, etc.) to create clear visibility and control of cash collections. Other sources of data may also be accessed.

In addition, Image Presentment Module 154 may use image based or digital presentment of paper-based transactions to realize various features and functions, such as acceleration of cash flow and improved management of working capital. Other benefits may include improved cash forecasting based on historical evaluation and analysis; managed credit exposure by trading partner; reduce processing costs through straight-thru processing business models that are supported by the bank; improved management control by providing online image and data visibility to financial transactions; ability to more effectively contest and collect short payments with trading partners by automating the exception notification and resolution process; reduce key order to cash performance metrics such as “Days to Pay” or “Days Sales Outstanding” associated with short-payments and other types of payment deductions; and improved customer service to keep trading partner relationship satisfaction high.

Image/Data Aggregation Module 154 may create virtual aggregation and intersections of in-transit financial information between a provider and customers, for example. Financial data and images that can be aggregated may include purchase orders, invoices, payments (e.g., checks, ACH, FEDI, credit cards, etc.), remittance advice, payment returns, etc. The in-transit point view may represent the various states that a payment made against a purchase order goes through from a request for payment, payment authorized, payment received and cash posted to accounts receivable, for example. By providing in-transit points of view of financial transactions, customers are better able to forecast cash positions, manage credit exposure and generate working capital. In addition, Image/Data Aggregation Module 154 may include an upload/import function that facilities capture of data, such as remittance data, from various sources and may further correspond the data to the appropriate source(s) accordingly.

Invoice Matching Module 156 provides a matching process that reconciles payments. One exemplary embodiment may involve using header information. With a simple file structure based on header information of each invoice or statement presented, the transaction output of the repository, e.g., Repository 170, may be enriched to introduce MICR-based identification of payment records and to distinguish exception payments from those that are considered “clean” and available for straight-through processing to a system of record. Further, the transaction system responsible for aggregating transmission data that is sent via FTP or some other method to an organization may carry codes that allow a customer to identify exceptions prior to posting to a system, thereby providing a tool to prevent exception items from entering the system of record. An organization may derive value because the matching process that reconciles payments received with unpaid invoices relieves them of the burden and responsibility for managing a dedicated system for cash preprocessing. Other methods for invoice matching based on other data or characteristics may be implemented.

Invoice matching enables lockbox clients to establish and maintain payment to invoice reconcilement business rules at the bank to achieve straight-thru auto cash posting results. For example, any transaction that does not meet predefined business rules may be automatically classified as an exception. Exceptions may then be presented online to give clients an opportunity to “repair” the transaction prior to transmission. An embodiment of the present invention eliminates posting latency found with traditional auto cash business models that depend on receipt of an overnight data transmission from a lockbox bank—enabling clients to accelerate revenue recognition at a customer and invoice level.

Features and functionality associated with invoice matching of the present invention may be applied to various examples and applications. For example, from the payment and remittance documentation, it may be unclear as to how much of the payment needs to be allocated to one or more individual entities. Thus, one payment may be made to multiple entities where the payment may be allocated to the appropriate entity or entities. Invoice matching of an embodiment of the present invention may implement business rules and capabilities to facilitate the allocation. According to another example, payments may be received with alternative index values such as Shipping or Bill of Lading numbers. In this scenario, an embodiment of the present invention may convert data received to a receiver preferred value (e.g., Invoice Number, etc.) if the payer elects to include a different transaction value in their remittance advice. In another example which may involve EFT Payments, a payer may pay using a wire transfer or ACH (e.g., CCD format, other format, etc.) with no remittance detail. For example, CCD format may represent a format used by the ACH settlement system that contains information about the originator and receiver of a payment order, without any remittance information. An embodiment of the present invention may allow the client to add remittance information to EFT payments prior to daily or other transmission. According to another example, payments may be received with truncated or incomplete invoice numbers. An embodiment of the present invention may convert partial or truncated invoice numbers to the receiver preferred value prior to transmission. In another example which may involve a duplicate payment filter, identification of duplicate payments may drive exception condition and workflow. Another example may involve short payments within tolerance where a write-off or discount tolerance may be set at a subsidiary level to facilitate auto cash posting of short payments within a pre-defined tolerance. According to another example involving check only payments, a payer may generate a check without remittance advice documentation. An embodiment of the present invention may allow the client to add remittance information to EFT payments prior to daily or other transmission. In addition, mis-keyed data captured in lockbox or supplied by the client on ACH payments may be corrected or repaired prior to transmission. According to another example, payer specific reconciliation business logic provides the ability to document and retain the payment practices of payers. Thus, evaluation of the payment practices may result in the development of additional matching business rules that may be specific to the payer thereby further reducing exceptions.

Exception Resolution 158 may provide the tools for engaging customer service representatives, trading partners and/or other participants in the resolution of exception transactions. Authorized users may review and add supplemental information to previously processed transactions to facilitate collaborative communication and resolution of previously identified exceptions. Further, the system may be configured to repair the transaction prior to release of the same transaction to a system for posting purposes, thereby effectively closing the loop on a straight-through processing business model. By introducing a set of entitlements that make it possible for payers (e.g., customers, trading partners, etc.) to have secure, partitioned views into the repository, a company will be in position to accrue additional benefits. An embodiment of the present invention generates additional value by eliminating exceptions and for those that remain creating an environment to track, resolve and manage exceptions across the enterprise and with trading partners. Accordingly, this provides the ability to fine-tune auto cash posting results by eliminating exceptions and automating the exception resolution process.

Invoice information may be used to quick-fill data, validate captured data and to drive presentment based on condition of an individual transaction, thereby creating opportunities to present exceptions to cross-functional areas within the enterprise and bypassing the need to have personnel in A/R touch the items to simply forward them onto someone else for resolution. Once notified, the cross-functional area may be provided tools within the application to take action to close the transaction or to create further dialogue directly with their trading partner. By providing support for trading partner interaction, an important payer behavior may be established that can lead to adoption of end-to-end electronic business models such Electronic Invoice Payment and Presentment (EIPP) systems over time. EIPP adoption may include providing a compelling reason for payers to go outside of their current process to use a solution that is not within their control. An embodiment of the present invention is directed to an online dialogue between the payer and seller for EIPP adoption.

Returns Management Module 160 allows customers to integrate electronic payments and return check images into a single, consolidated transaction view. For example, the view or reporting may include the date of return, the reason the item was returned, the disposition and/or other information. In addition to reporting, an embodiment of the present invention may include an ability to associate the return back to the original lockbox transaction to provide visibility to the invoice remittance information associated with the transaction—enabling the client to reopen the invoices associated with the return payment. An embodiment of the present invention provides for intra-day decisioning. For example, clients may request access to high dollar value returns before a second redeposit attempt is made. An embodiment of the present invention may provide for intra-day online presentment of returns where the client may provide direction to the bank to redeposit, stop or perform other action concerning the transaction.

Alerts/Event Driven Reporting Module 164 may provide Event-Driven Notification which may include adding intelligence to the lockbox process. Module 164 may provide reporting tools to manage data, identify trends as well as track and predict customer behavior. Users may identify conditions for alerts via preferred modes of contact (e.g., email, voicemail, cellular phone, etc.). Module 164 may provide a notification of payment events, transaction conditions, etc. For example, transactions from individual remitters may be tracked where the customer may be notified via e-mail or other form of communication when payments are received from designated remitters or based on other predefined event or condition. In addition, users may generate customized reports based on various factors and conditions. Further, reports may be automatically generated based on predetermined schedules, events and/or other conditions.

Other Module 164 may provide EFT/Lockbox Presentment, Electronic invoice and/other other functionality. For example, EFT/Lockbox presentment may reduce financial exposure associated with timely processing of payments and integration of remittance information into ERP systems of record.

Receivables Repository 170 may be an extension of remote image capture processing centers thereby making virtually limitless combinations and aggregation of payment and remittance information possible. Receivables Repository 170 provides various benefits and advantages. For example, an extension of a core transaction processing system provides customers and trading partners simultaneous access to financial trade cycle information, document images, and/or other information. In addition, customers may seamlessly transition from paper-based business models to full end-to-end electronic solutions at the pace that makes sense to an organization. Receivables Repository 170 may also support advanced web-based Business Models such as Invoice Matching through Module 156, Online Repair of Lockbox Exceptions through Module 158 and EIPP and/or other functions.

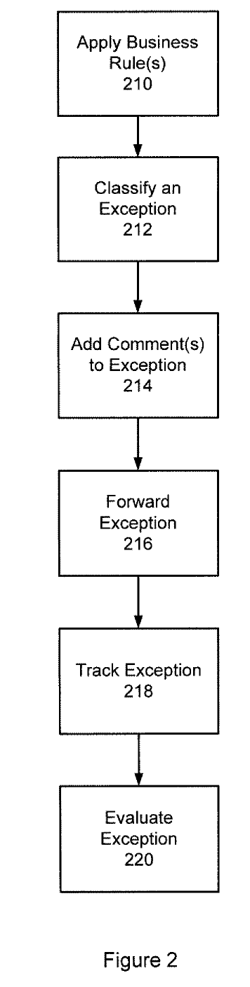

FIG. 2 is an exemplary flowchart illustrating a method for managing receivables, according to an embodiment of the present invention. At step 210, one or more business rules may be applied. At step 212, an exception may be classified based on the business rules. At step 214, one or more comments may be added to assist one or more responsible individuals or other recipient. At step 216, the exception may be forwarded to the one or more responsible individuals or other recipient. At step 218, the exception may be tracked. At step 220, the exception may be evaluated. The order illustrated in FIG. 2 is merely exemplary. While the process of FIG. 2 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

At step 210, one or more business rules may be applied. System 150 may be configured to retain business rules and reconciliation logic that matches the unique workflow and process flow of an entity, such as a corporate enterprise. System 150 may support workflow and offer the ability to record and filter exception transactions using codes, such as client-defined reason codes. Moreover, System 150 may provide natural migration paths and seamless integration to electronic, end-to-end sessions between trading partners and/or other participants.

An embodiment of the present invention may leverage systematic identification of customers by using the MICR line to drive payer-specific business rules to provide clearer identification or interpretation of payer supplied information for the benefit of the receiver. In addition, the MICR line of a payment may be used to drive workflow partitioning of specific receivables transactions generated by individual customers. As a result, delays in revenue recognition may be reduced by at least one day through same-day online repair and resolution of exception transactions. An embodiment of the present invention offers a single online image solution that combines the benefits of auto cash posting business rules with same-day exception identification and repair. In addition, retention of receivables related image and data may be consolidated to a single repository, e.g., Repository 170, for reporting and data mining purposes. This may include multiple paper-based lockbox sites, EFT, ACH, Wire Transfer, credit card, and check return transactions into a Receivables Repository 170.

At step 212, an exception may be classified based on the business rules. For example, based on the business rules, an exception may be identified by category, type, and/or other factor or characteristic. For example, the system may provide the ability to identify exceptions, age the transactions and further offers management tools to repair open receivables with exceptions prior to import to the accounts receivable system of record. Reason codes may include, for example, Payment in Balance, Short Payment, Short Payment within Tolerance, Over Payment, Invalid Reference Number and Duplicate Payment. Other reason codes may apply.

At step 214, one or more comments may be added to assist one or more responsible individuals or other recipient. Users with the Workflow & Notes roles may create notes associated with a transaction and assign (e.g., reassign, unassign, etc.) a user to or from a transaction. A user with this role may bulk assign (e.g., reassign, unassign, etc.) a single user to many transactions or at an individual transaction level, assign (e.g., reassign, unassign, etc.) a user to a transaction. In addition to assigning transaction and creating notes, users may modify exceptions of transactions, change the status of an assigned transaction, add a reason code to a transaction and/or perform other actions.

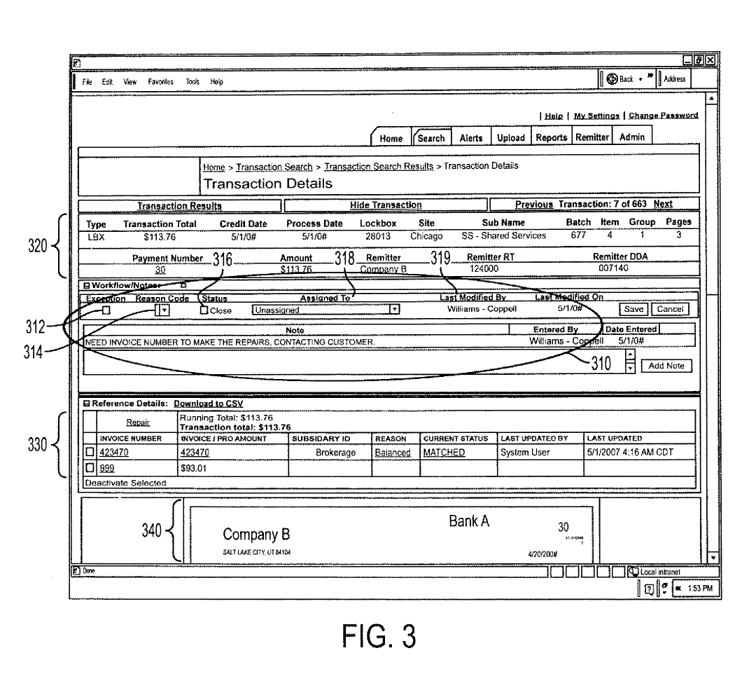

FIG. 3 illustrates an exemplary screen shot of Exception Management and Notes function, according to an embodiment of the present invention. Transaction details may include payment identifiers 320, exception flags 312, reason code assignment 314, assigned to assignment 318, notes 310, audit tracking, reference details 330, check & document image 340, and link to edit/repair queue. Other data and functionality may also be provided. Exception transactions may be automatically marked on the system to reduce time and effort at finding and managing the transactions on the system. For example, an exception flag 312 may identify the exception, along with reason code 314 and status 316. Notes 310 can be added to transactions to facilitate clear, concise online dialogue with cross-functional departments and partners.

The user may assign the exception to a responsible individual, unit, group, department and/or other recipient. This assignment may be performed automatically based on rules or the assignment may be performed manually. Also, this field may be pre-populated or narrowed to a smaller subset of potential recipients based on one or more defined rules. According to another example, this field may default to another field, such as the “Last Modified By” entity identified by 319. Reference details 330 identifies invoices in the repair process.

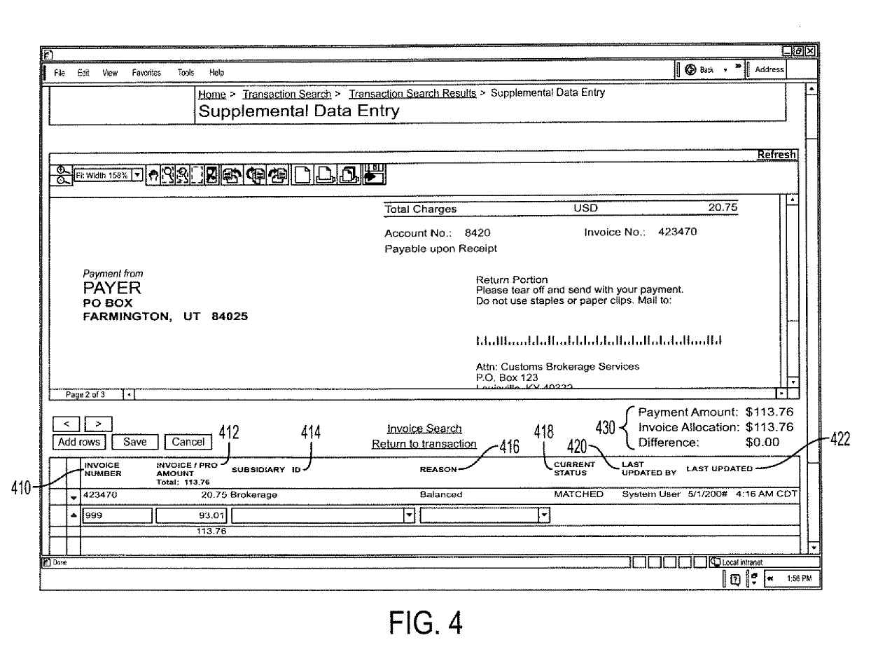

FIG. 4 illustrates an exemplary screen shot of a Supplemental Data Entry screen shot, according to an embodiment of the present invention. FIG. 4 enables exception repair and supplemental data entry. In this example, image data may be displayed while a user may supplies data for exception repair. For example, invoice number 410, invoice amount 412, subsidiary id 414, reason 416 and/or other data may be submitted. In addition, current status 418, last updated by 420, last updated 422 and/or other information may be displayed. Data may be entered by drop down, free-form and/or other data entry method. Reason data may include a reason/explanation for the exception or transaction which may include “balanced,” “transferred,” etc. Users may view a payment amount, invoice allocation and difference amount, as shown by 430 to track the repair process.

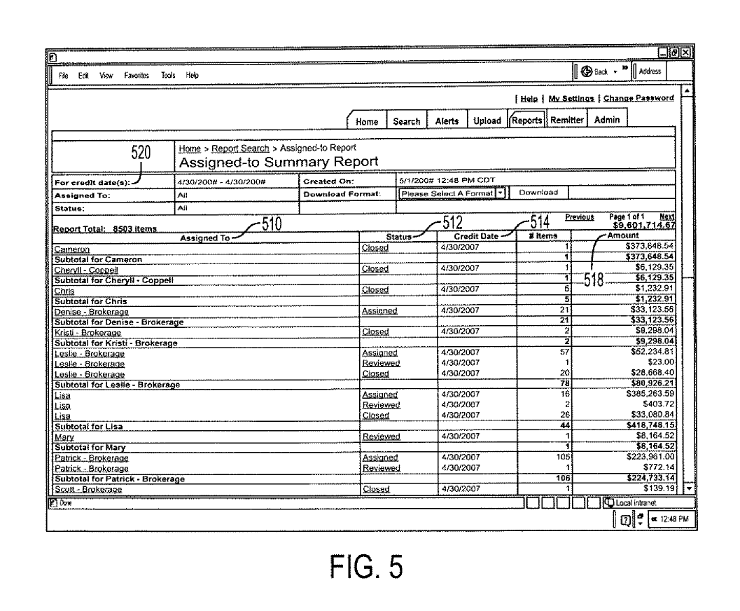

At step 216, the exception may be forwarded to the one or more responsible individuals or other recipient. FIG. 5 illustrates an exemplary screen shot of an “assigned to” workflow function, according to an embodiment of the present invention. Transactions may be assigned to individuals by remitter or batch of transactions where supervisors may track exception resolution progress. This function is also shown at 318 in FIG. 3. For example, FIG. 5 illustrates an Assigned-to summary report. Reports may be customized by date, assigned-to data, status and/or other filters. In FIG. 5, assigned-to entity 510, status 512, credit date 514, number of items 516 and amount 518 may be displayed. Status 512 may include closed, assigned, reviewed and/or other status. A date range 520 is also available. In addition, sub-totals for each responsible individual may also be displayed. Other data may be displayed in various formats. According to an exemplary application, this view allows the user to determine how items are aging and respond accordingly.

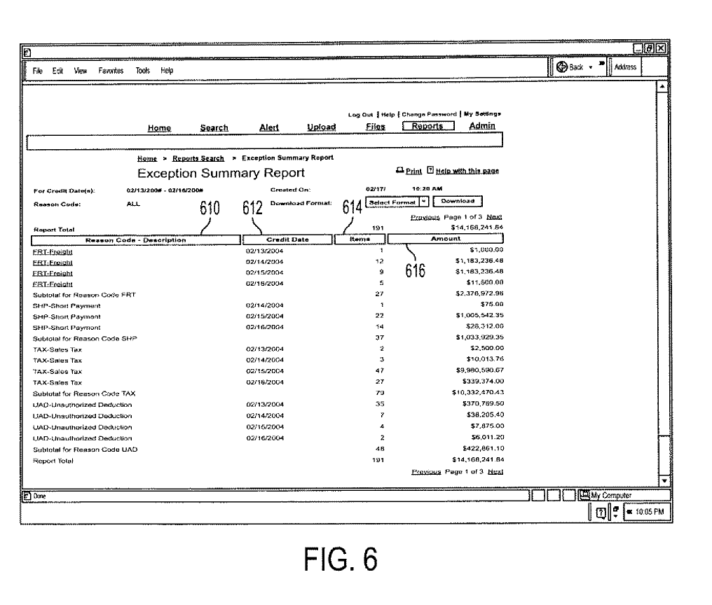

At step 218, the exception may be tracked. At step 220, the exception may be evaluated. FIG. 6 illustrates an exemplary screen shot of Root Cause Exception Analysis function, according to an embodiment of the present invention. Exceptions may be classified by codes, such as company-defined reason codes, user-defined codes, government-defined codes, and other criteria for defining codes, serving as a source for root cause evaluation and analysis over time. FIG. 6 illustrates an Exception summary report. For example, Reason Code/Description 610, Credit Data 612, Items 614, Amount 616 and/or other data may be displayed. In addition, subtotals for each reason code may be displayed. Reason codes assigned by System 150 may be based on reconciliation business rules to determine what may be included in the daily transmission and what may be filtered into the shared services exception repair queue. In this example, reason codes may include FRT: freight, SHP: short payment, TAX: sales tax, UAD: unauthorized deduction. For example, the reason codes may be applied at an invoice level. Transmission and exception queue preferences may be established at a subsidiary level. Invoice Repair Reason Codes may be used to enhance the business rules as the repair reasons may be identified. Customers may create, edit and activate/deactivate the companies' reason codes and manually assign them through the Transaction Details screen as part of the invoice repair process.

System 150 allows an entitled user to find a transaction requiring invoice repair and manually repair it. Once done editing, and the changes saved, the user may return to the transaction details page to close the transaction. This would signify that modifications to fix “exceptional” invoices have been made. In addition, an “auto close” workflow feature may be available. In this example, the transaction being repaired may be marked as closed when the user saves the transaction (or other predetermined action). The user would not need to return to the transaction details screen to mark the transaction as closed—this would occur automatically.

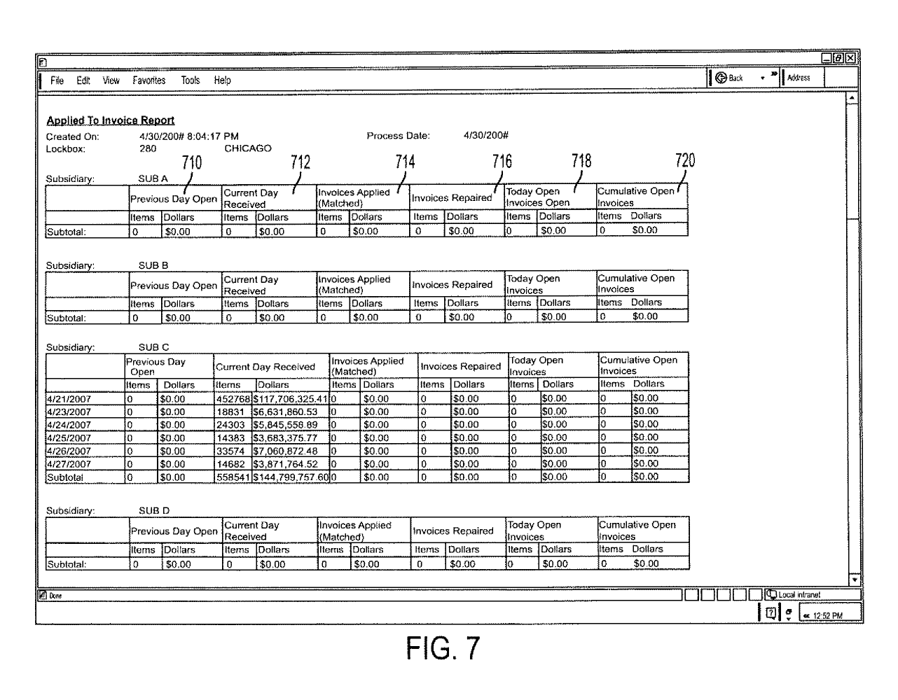

FIG. 7 illustrates an exemplary screen shot for Exception Tracking & Analysis function, according to an embodiment of the present invention. For each subsidiary, previous day open 710, current day received 712, invoices applied (matched) 714, invoices repaired 716, today open invoices 718, and cumulative open invoices 720 may be displayed. This type of report may ensure that the age and number of exceptions are tracked so that items may be escalated and routed as needed. As a result, an embodiment of the present invention assists the client in keeping exception exposure to a minimum.

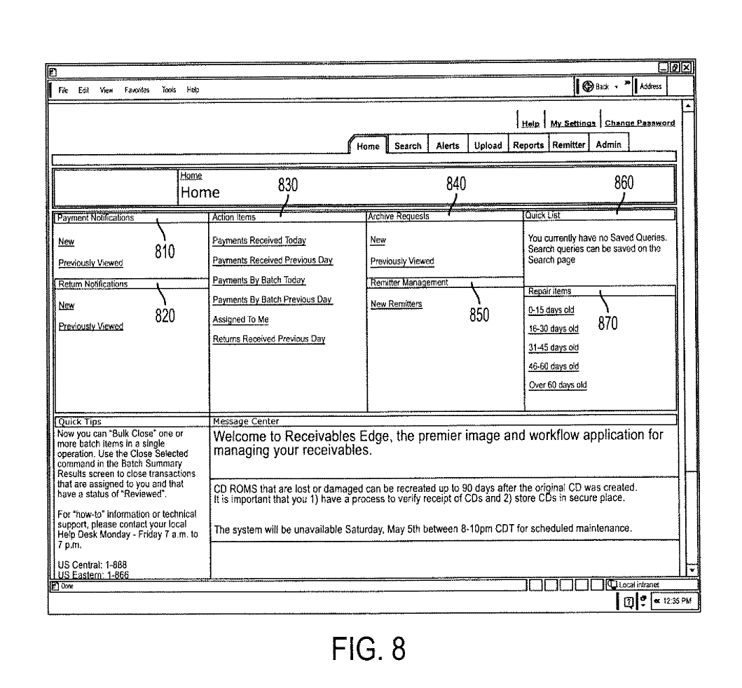

FIG. 8 illustrates an exemplary screen shot of a Receivables Management System, according to an embodiment of the present invention. As shown by the screen shot, various functions may be available, such as payment notifications 810, return notifications 820, action items 830, archive requests 840, remitter management 850, quick list 860, and repair items 870. For example, Action Items link provides a quick link to new transactions. Quick List 860 may refer to saved queries. The Receivables Management System may be customized based on user preferences, needs and/or other considerations.

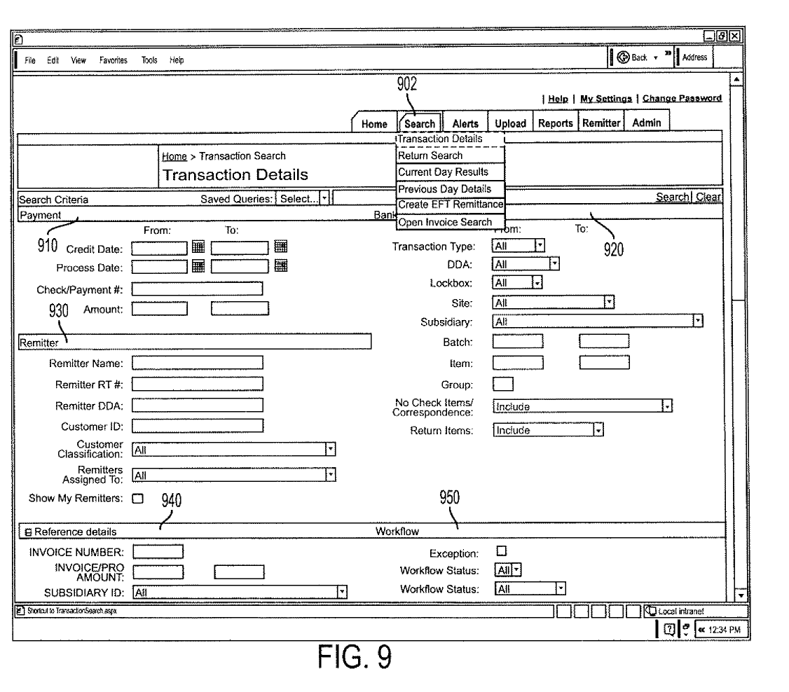

FIG. 9 illustrates an exemplary screen shot of a Robust Search Engine, according to an embodiment of the present invention. Transaction search results may include index values captured from a check. Search engines can be conducted using key references data such as invoice numbers invoice dates, purchase order numbers and other data captured through the lockbox or Electronic Funds Transfer (EFT) reporting processes. Therefore, customers may search for transactions by descriptive search terms and validate payment received and/or other information. Users may input various search criteria, such as Payment 910, Bank Identifier 920, Remitter 930, Reference Details 940, and Workflow 950.

In addition, specific searches may be available to the user. For example, under the “Search” tab 902, searches may be relevant to specific tasks, such as Transaction Search, Return Search, Current Day Results, Previous Day Results, Create EFT Remittance and Open Invoice Search. Other task specific searches may also be available to users.

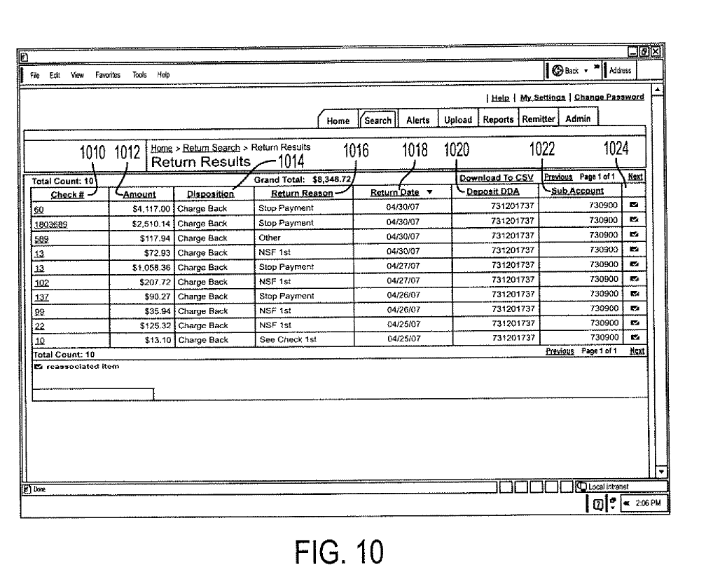

FIG. 10 illustrates an exemplary screen shot of Check Return Re-Association function, according to an embodiment of the present invention. Check returns may be automatically re-associated with the original lockbox transaction to aid in unwinding transactions using customer number, invoice number details and/or other criteria. For example, check number 1010, amount 1012, disposition 1014, return reason 1016, return date 1018, deposit DDA 1020 and sub account 1022 may be displayed. Disposition data may include charge back and/or other action. Return Reason may include stop payment, NSF 1^{st}, account closed, unknown bank account, etc. Column 1024 may indicate whether the item is a re-associated item. Through this functionality, check returns may be re-associated to previously captured transactions and supplemental remittance data that originated from a Lockbox Capture processing platform.

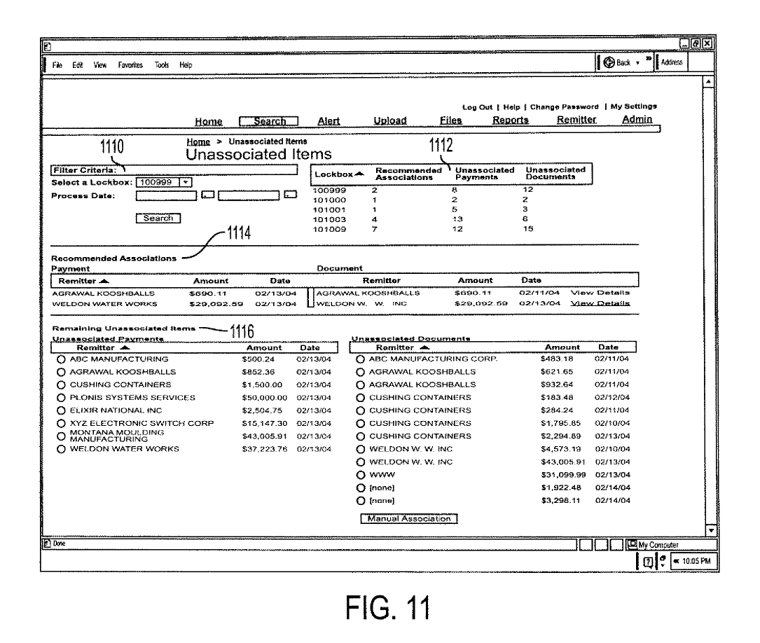

FIG. 11 illustrates an exemplary screen shot of Split Payment and Remit Advice Re-Association function, according to an embodiment of the present invention. Remittance advice transactions may be imported or added from another source. As payments are received through EFT, lockbox channels, and/or other source, the payments may be matched to outstanding remittance advices creating a “complete” transaction prior to transmission. Users may associate payment and remittance advice information captured from two or more different systems. In this scenario, users may receive payment information through one source (e.g., low value box) and remittance information may be delivered through another (e.g., Image Central). Assuming that both systems are integrated to feed data into the Receivables Repository, an embodiment of the present invention provides the ability to combine both input records to create a single consolidated transaction report for the client. An embodiment of the present invention leverages reconciliation and matching logic.

As shown in FIG. 11, users may enter filter criteria at 1110. Users may view a count of recommended associations, unassociated payments and unassociated documents at 1112. In addition, detailed information for recommended associations for payments and documents may be displayed at 1114. Remaining unassociated payments and documents may be displayed at 1116.

In addition, System 150 may provide users control over the environment. For example, users may establish primary and secondary e-mail or pager addresses, select notification methods and preferences and determine personal settings like default sort orders on search result screens and activation of sticky notes and jump to page functionality.

According to an embodiment of the invention, the systems and processes described in this invention may be implemented on any general or special purpose computational device, either as a standalone application or applications, or even across several general or special purpose computational devices connected over a network and as a group operating in a client-server mode. According to another embodiment of the invention, a computer-usable and writeable medium having a plurality of computer readable program code stored therein may be provided for practicing the process of the present invention. The process and system of the present invention may be implemented within a variety of operating systems, such as a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of the system or systems embodying the present invention may comprise computer readable program code in the form of functional instructions stored in the computer-usable medium such that when the computer-usable medium is installed on the system or systems, those components cause the system to perform the functions described. The computer readable program code for the present invention may also be bundled with other computer readable program software. Also, only some of the components may be provided in computer-readable code.

Additionally, various entities and combinations of entities may employ a computer to implement the components performing the above-described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, the system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

While the invention has been particularly shown and described within the framework of receivables management, it will be appreciated that variations and modifications can be effected by a person of ordinary skill in the art without departing from the scope of the invention. Furthermore, one of ordinary skill in the art will recognize that such processes and systems do not need to be restricted to the specific embodiments described herein.

1. A computer implemented method for managing receivables, the method comprising the steps of:
maintaining a repository for receivables data comprising payment data;
applying one or more automated rules to the payment data for identifying an exception wherein the exception represents a discrepancy between an actual payment and an expected payment;
forwarding the exception to one or more designated recipients for resolution;
tracking the exception;
evaluating the exception to identify a root cause of the discrepancy; and
storing data associated with the exception in the repository.

2. The method of claim 1, wherein the one or more automated rules are based on MICR line data.

3. The method of claim 1, wherein the one or more automated rules are based on one or more payer defined codes.

4. The method of claim 1, wherein the one or more automated rules are based on one or more user defined codes.

5. The method of claim 1, wherein the payment data comprises image data.

6. The method of claim 1, wherein the payment data comprises remittance information comprising one or more of check stubs, invoice payments and coupons.

7. The method of claim 1, wherein the payment data comprises data associated with one or more of checks, automated clearing house, electronic funds transfer, wire transfers, check returns, electronic data interchange, image replacement documents.

8. The method of claim 1, further comprising the step of:
adding one or more supplemental notes associated with the exception intended for the one or more designated recipients.

9. The method of claim 1, wherein the one or more designated recipients comprise one or more of customer service representatives, trading partners, participants, authorized users, business units, and business groups.

10. The method of claim 1, further comprising the step of:
generating one or more reports based on one or more conditions.

11. The method of claim 1, wherein each exception is identified by a reason code that identifies a repair reason.

12. The method of claim 1, further comprising the step of:
enabling one or more users to access one or more personalized views for managing the receivables data.

13. The method of claim 12, wherein the one or more users collaborate and communicate with each other.

14. A computer implemented system for managing receivables, the system comprising:
a repository for maintaining receivables data comprising payment data; and
a module for applying one or more automated rules to the payment data for identifying an exception wherein the exception represents a discrepancy between an actual payment and an expected payment; forwarding the exception to one or more designated recipients for resolution; tracking the exception; and evaluating the exception to identify a root cause of the discrepancy;
where data associated with the exception is stored in the repository.

15. The system of claim 14, wherein the one or more automated rules are based on MICR line data.

16. The system of claim 14, wherein the one or more automated rules are based on one or more payer defined codes.

17. The system of claim 14, wherein the one or more automated rules are based on one or more user defined codes.

18. The system of claim 14, wherein the payment data comprises image data.

19. The system of claim 14, wherein the payment data comprises remittance information comprising one or more of check stubs, invoice payments and coupons.

20. The system of claim 14, wherein the payment data comprises data associated with one or more of checks, automated clearing house, electronic funds transfer, wire transfers, check returns, electronic data interchange, image replacement documents.

21. The system of claim 14, wherein one or more supplemental notes associated with the exception intended for the one or more designated recipients are added.

22. The system of claim 14, wherein the one or more designated recipients comprise one or more of customer service representatives, trading partners, participants, authorized users, business units, and business groups.

23. The system of claim 14, further comprising:
a report module for generating one or more reports based on one or more conditions.

24. The system of claim 14, wherein each exception is identified by a reason code that identifies a repair reason.

25. The system of claim 14, wherein one or more users access one or more personalized views for managing the receivables data.

26. The system of claim 25, wherein the one or more users collaborate and communicate with each other.

27. A computer readable media comprising code to perform the steps of the method of claim 1.

28. A computer implemented method for managing receivables, the method comprising the steps of:
maintaining a repository for receivables data comprising payment data, wherein the payment data comprises image data and remittance information comprising one or more of check stubs, invoice payments and coupons and wherein the payment data further comprises data associated with one or more of checks, automated clearing house, electronic funds transfer, wire transfers, check returns, electronic data interchange, image replacement documents;
applying one or more automated rules to the payment data for identifying an exception wherein the exception represents a discrepancy between an actual payment and an expected payment, wherein the one or more automated rules are based on one or more of MICR line data, payer defined codes and user-defined codes;
adding one or more supplemental notes associated with the exception intended for the one or more designated recipients,
forwarding the exception to one or more designated recipients for resolution, wherein the one or more designated recipients comprises one or more of customer service representatives, trading partners, participants, authorized users, business units, and business groups;
tracking the exception, wherein each exception is identified by a reason code that identifies a repair reason;
evaluating the exception to identify a root cause of the discrepancy;
storing data associated with the exception in the repository; and
enabling one or more users to access one or more personalized views for managing the receivables data, wherein the one or more users collaborate and communicate with each other.
